(19) United States
(12) Patent Application Publication
(10) Pub. No.: US 2020/0201153 A1
(43) Pub. Date: Jun. 25, 2020

(54) LASER LIGHT SOURCE AND LASER PROJECTOR

(71) Applicant: Hisense Laser Display Co., Ltd., Qingdao (CN)

(72) Inventors: Hongyan LIU, Qingdao (CN); Di GAO, Qingdao (CN); Wei LI, Qingdao (CN); Yong ZHANG, Qingdao (CN); Zhen WANG, Qingdao (CN)

(73) Assignee: Hisense Laser Display Co., Ltd., Qingdao (CN)

(21) Appl. No.: 16/586,285

(22) Filed: Sep. 27, 2019

Related U.S. Application Data
(63) Continuation of application No. PCT/CN2019/104630, filed on Sep. 6, 2019.

(30) Foreign Application Priority Data
Dec. 19, 2018 (CN) 201811557926.5
Dec. 19, 2018 (CN) 201811558952.X

(51) Int. Cl. G03B 21/20

(52) U.S. Cl. CPC G03B 21/204; G02B 26/008; G03B 21/208

(57) ABSTRACT

The present disclosure describes a laser light source. The laser light source includes first laser emitting first laser light; and a phosphor wheel comprising a plurality of regions arranged along a first circumferential direction. When the first laser light is transmitted onto the plurality of regions of the phosphor wheel, the plurality of regions of the phosphor wheel are configured to emit light comprising at least one of three colors. The plurality of regions of the phosphor wheel comprise at least one pair of first regions configured to emit light of a same color. The plurality of regions of the phosphor wheel comprise one second region spaced between each pair of the at least one pair of first regions. The light emitted from the first region and the light emitted from the second region comprise different colors.

### CROSS-REFERENCE TO RELATED APPLICATIONS

This application is a continuation application of International Application No. PCT/CN2019/104630 filed on Sep. 6, 2019, which claims priority to Chinese Patent Application No. 201811558952.X filed on Dec. 19, 2018 and Chinese Patent Application No. 201811557926.5 filed on Dec. 19, 2018, the entire contents of which are incorporated herein by reference.

### TECHNICAL FIELD

The present disclosure relates to laser projection display, and in particular to a laser light source and a laser projector.

### BACKGROUND

A laser light source is a light source that has high brightness and strong directivity and emits a monochromatic coherent light beam. Due to many advantages, the laser light source is gradually applied to the field of projection display in recent years. Generally, the current laser light source includes at least: a laser, a phosphor wheel, a filter wheel and a light rod. The laser light source works in the following process: the laser emits laser light, the laser light is irradiated on the phosphor wheel to excite a phosphor powder on the phosphor wheel to output fluorescence of at least one color, and then light of at least one color is obtained by filtering the fluorescence of at least one color through the filter wheel and then the laser light and the light of at least one color are homogenized by the light rod to realize a illumination function of the laser light source.

### SUMMARY

The present disclosure describes an embodiment of a laser light source. The laser light source includes first laser emitting first laser light; and a phosphor wheel comprising a plurality of regions arranged along a first circumferential direction. When the first laser light is transmitted onto the plurality of regions of the phosphor wheel, the plurality of regions of the phosphor wheel are configured to emit light comprising at least one of three colors. The plurality of regions of the phosphor wheel comprise at least one pair of first regions configured to emit light of a same color. The plurality of regions of the phosphor wheel comprise one second region spaced between each pair of the at least one pair of first regions. The light emitted from the first region and the light emitted from the second region comprise different colors.

The present disclosure describes another embodiment of a laser light source. The laser light source includes a blue laser configured to emit blue laser light. The laser light source also includes a color wheel comprising a plurality of regions arranged along a first circumferential direction and a plurality of regions arranged along a second circumferential direction, the color wheel configured to output three primary colors in time sequence, the three primary colors comprising a red color, a blue color and a green color. The plurality of regions arranged along the first circumferential direction comprise at least one pair of first regions configured to emit light of a same color. The plurality of regions arranged along the first circumferential direction comprise one second region spaced between each pair of the at least one pair of first regions. The light emitted from the first region and the light emitted from the second region comprise different colors. A fluorescence region comprises at least one of: the first region, the second region, or the first and second regions. The plurality of regions arranged along the second circumferential direction comprise filter regions corresponding to the first region and the second region.

The present disclosure describes another embodiment of a laser projector. The laser projector includes a laser light source configured to emit a light beam, an optical engine configured to modulate the light beam emitted from the laser light source into an image beam when irradiated by the light beam, and a projection lens configured to project the image beam. The laser light source includes a blue laser configured to emit blue laser light. The laser light source also includes a color wheel comprising a plurality of regions arranged along a first circumferential direction and a plurality of regions arranged along a second circumferential direction, the color wheel configured to output three primary colors in time sequence, the three primary colors comprising a red color, a blue color and a green color. The plurality of regions arranged along the first circumferential direction comprise at least one pair of first regions configured to emit light of a same color. The plurality of regions arranged along the first circumferential direction comprise one second region spaced between each pair of the at least one pair of first regions. The light emitted from the first region and the light emitted from the second region comprise different colors. The first region comprises a fluorescence region. The plurality of regions arranged along the second circumferential direction comprise filter regions corresponding to the first region and the second region.

### BRIEF DESCRIPTION OF THE DRAWINGS

To describe some examples of the present disclosure more clearly, accompanying drawings required in descriptions of the examples of the present disclosure will be briefly introduced below. It is apparent that the accompanying drawings described below are merely some examples of the present disclosure and other drawings may also be obtained by those of ordinary skill in the art without paying creative work.

FIG. 1 is a schematic diagram illustrating an implementation environment according to some examples of the present disclosure.

FIG. 2 is a schematic diagram illustrating a structure of a laser light source according to some examples of the present disclosure.

FIG. 3 is a schematic diagram illustrating a structure of a phosphor wheel according to some examples of the present disclosure.

FIG. 4 is a schematic diagram illustrating an arrangement of a fluorescence region and a transmission region according to some examples of the present disclosure.

FIG. 5 is a schematic diagram illustrating an arrangement of a fluorescence region and a transmission region according to some examples of the present disclosure.

FIG. 6 is a schematic diagram illustrating an arrangement of a fluorescence region and a transmission region according to some examples of the present disclosure.

FIG. 7 is a schematic diagram illustrating a structure of a phosphor wheel according to some examples of the present disclosure.

FIG. 8 is a schematic diagram illustrating a structure of a filter wheel according to some examples of the present disclosure.

FIG. 9A is a schematic diagram illustrating a structure of a color wheel according to some examples of the present disclosure.

FIG. 9B is a schematic diagram illustrating a structure of another color wheel according to some examples of the present disclosure.

FIG. 10 is a schematic diagram illustrating a structure of another laser light source according to some examples of the present disclosure.

FIG. 11A is a schematic diagram illustrating a structure of still another laser light source according to some examples of the present disclosure.

FIG. 11B is a schematic diagram illustrating a structure of yet another laser light source according to some examples of the present disclosure.

FIG. 12 is a schematic diagram illustrating a structure of a color wheel according to some examples of the present disclosure.

FIG. 13 is a schematic diagram illustrating a color zoning of a color wheel according to some approaches.

The accompanying drawings, which are incorporated in and constitute a part of the present description, illustrate examples consistent with the present disclosure and serve to explain the principles of the present disclosure together with the description.

### DETAILED DESCRIPTION OF THE EMBODIMENTS

To describe the object, the technical solutions and advantages of the present disclosure more clearly, the present disclosure will be described clearly and fully below in combination with accompanying drawings. It is apparent that the described examples are merely part of examples of the present disclosure rather than all examples. Other examples achieved by those of ordinary skill in the art based on the examples in the present disclosure without paying creative work shall all fall into the scope of protection of the present disclosure.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. Similarly, the phrase “in one implementation” or “in some implementations” as used herein does not necessarily refer to the same embodiment and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

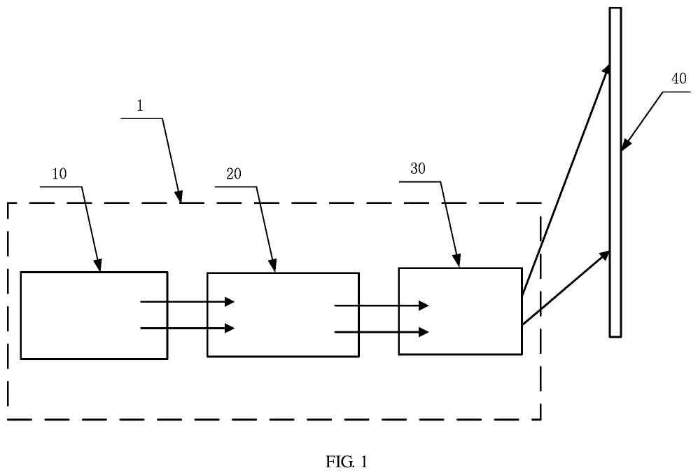

FIG. 1 is a schematic diagram illustrating an implementation environment according to some examples of the present disclosure. The implementation environment is applied to a laser projector. The laser projector includes a laser light source 10, an optical engine 20 and a projection lens 30. The laser light resource 10, the optical engine 20 and the projection lens 30 are arranged sequentially along a light beam transmission direction. The laser light source 10 is configured to emit a light beam. The optical engine 20 is configured to modulate a light beam emitted from the laser light source 10 into an image beam when irradiated by the light beam. The projection lens 30 is configured to project the image beam onto a projection screen 40.

Illustratively, the laser light source 10, the optical engine 20 and the projection lens 30 described above are applied to a laser projector 1. At present, the laser projector has a plurality of laser light sources. The laser light source includes at least one laser, and is configured to emit laser light of at least one color. Illustratively, the laser light source is a monochromatic laser source, that is, includes one laser emitting laser light of one color, or a dual-color laser source, that is, includes a plurality of lasers emitting laser light of two colors.

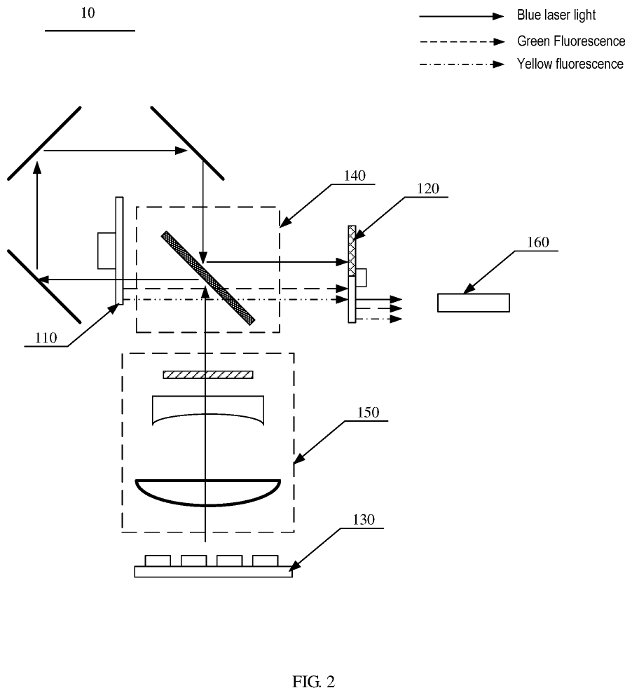

FIG. 2 is a schematic diagram illustrating a structure of a laser light source 10 according to some examples of the present disclosure. If one laser in the laser light source is a blue laser, the blue laser 130 is configured to emit blue laser light. The laser light source 10 includes a phosphor wheel 110, a filter wheel 120 and the blue laser 130.

Generally, the phosphor wheel and the filter wheel both include a plurality of regions. Two adjacent regions have different colors, and thus an obvious boundary is formed between two adjacent regions having different colors. A light spot emitted from the laser has a particular size. The light spot is highly possible to be irradiated on the boundary of two adjacent regions of the phosphor wheel, and the light emitted from the two regions has different colors. Therefore, after the light spot passes through the two regions, the colors of the emitted light are mixed, that is, a spoke light including more than one colors (also referred to as mixed light or spoke light) is generated, which is called a color mixing phenomenon. The light of mixed colors may make it difficult for the optical engine to identify a primary color from the light of mixed colors.

In some examples, the phosphor wheel 110 includes a plurality of regions arranged along a first circumferential direction. Illustratively, the number of the plurality of regions of the phosphor wheel 110 is 4 or 5. In some examples, the plurality of regions of the phosphor wheel 110 includes a fluorescence region and a transmission region. The fluorescence region is configured to emit fluorescence under the excitation of laser light, and the transmission region is configured to transmit laser light.

The light emitted from the plurality of regions of the phosphor wheel 110 has at least three colors. The plurality of regions of the phosphor wheel 110 includes at least one pair of first regions where the emitted light is of the same color, and one second region is spaced between the first regions of each pair. The light emitted from the first region and the second region is of different colors. The phosphor wheel 110 is rotated to output the light of different colors required by three primary colors. For example, blue laser light, green fluorescence and yellow fluorescence are output and red fluorescence is obtained by filtering the yellow fluorescence, thereby forming three primary colors. Optionally, blue laser light, green fluorescence and orange fluorescence are output and the red fluorescence is obtained by filtering the orange fluorescence, thereby forming three primary colors.

Further, the filter wheel 120 is in a light emitting path of the phosphor wheel 110. The filter wheel 120 has a plurality of regions arranged along a second circumferential direction. The plurality of regions of the filter wheel 120 are disposed corresponding to the plurality of regions of the phosphor wheel 110. The filter wheel 120 is configured to output red light, blue light and green light in a time sequence.

In conclusion, the laser light source according to some examples of the present disclosure generates less spoke light while providing primary color light of a plurality of time-sequence periods during one circle of rotation of the color wheel. In this case, one benefit is that complexity of performing light processing for the region by an electronic software program is reduced. For example, if the mixed color segment is not discarded but utilized, the duration of the mixed color segment is determined by performing recalculation for a proportion of white balance and accurately controlling a rotation position of the color wheel and then utilized, so that a reduced amount of spoke region light causes a reduction of the control complexity of the electronic software. When the spoke light is discarded, benefits may include that losses of a plurality of types of primary color light are reduced according to the above solution with less spoke region light. Therefore, a brightness loss of a whole projection picture is reduced, an influence of the lost primary color light on the proportion of the original white balance is also lowered, and a high-quality projection picture display is facilitated.

Further, by disposing a multi-zone color segment, the color wheel may provide, in at least two time-sequence periods during one rotation, complete light of three colors, which is also referred to as tri-color light (i.e., a three-primary-color light component). Therefore, a rotation speed of the color wheel is effectively increased, time of emitting one group of complete light of three colors by the color wheel is shortened, and a probability of occurrence of “a rainbow phenomenon” is reduced, thereby improving watching quality of the projection picture.

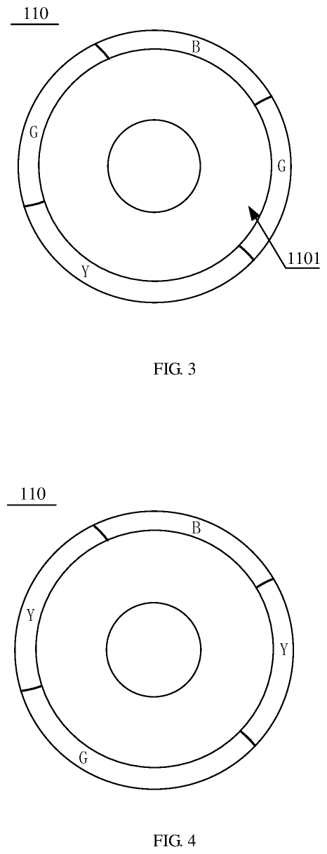

FIG. 3 is a schematic diagram illustrating a structure of a phosphor wheel according to some examples of the present disclosure. The phosphor wheel 110 includes a substrate 1101. The plurality of regions of the above phosphor wheel 110 is arranged on the substrate 1101 along a circumferential direction. The plurality of regions includes n fluorescence regions and “m” transmission regions. Illustratively, 1<n<5, 0<m<3, and 3<m+n<6. The light emitted from the plurality of regions has at least three colors, and the light emitted from every two adjacent regions has different colors. For example, the light emitted from the plurality of regions has green color (corresponding to a green fluorescence region G), yellow color (corresponding to a yellow fluorescence region Y) and blue color (corresponding to a transmission region B). Illustrative descriptions are made with one yellow fluorescence region Y, two green fluorescence regions G and one transmission region B on the substrate 1101 as shown in FIG. 3.

In some examples, each region on the phosphor wheel is in a fan shape or a fan-ring shape, and an area of each region is represented by a degree of a central angle corresponding to the region. Thus, the area of the emitted light of each region represents an angle of the emitted light of each region. The angle of the light emitted from the phosphor wheel includes an angle for spoke light and an angle for pure color light. In the case of ensuring the angle of the light actually emitted from the phosphor wheel is unchanged, the angle of the spoke light is negatively correlated to the angle of the pure color light. That is, the larger the angle of the spoke light is, the smaller the angle of the pure color light is.

To enable the fluorescence region to emit fluorescence of different colors under the excitation of the blue laser, green phosphor powder or yellow phosphor powder is provided on a surface of each fluorescence region. In this case, the light of the color corresponding to the phosphor powder is emitted by exciting the phosphor powder of the corresponding color when the fluorescence region is irradiated by the blue laser. Illustratively, in a case that the color of the light emitted from the above plurality of regions includes green, yellow and blue if the color of the light emitted from n fluorescence regions includes green and yellow, the n fluorescence regions include the green fluorescence region and the yellow fluorescence region, and the light emitted from m transmission regions is blue.

Users may desire higher picture quality of the projection screen. In one implementation, an image display frequency may be 240 Hz, and thus the three-color-segment phosphor wheel (a phosphor wheel with the yellow fluorescence region, the green fluorescence region and the transmission region) may need to increase a frequency of emitting the three-color light (yellow light, green light and blue light) so as to emit light of high frequency to the optical engine. Therefore, it is necessary for the three-color-segment phosphor wheel to increase a rotation frequency (or, a rotation speed or a rotation rate). However, a larger rotation speed may be associated with larger noise, resulting in bad experiences to users. In this case, to reduce the noise and improve the user experience, the phosphor wheel is enabled to emit one group of three-color light in a case of half a circle of rotation, in other words, emit two groups of three-color light which have same time-sequence periods during one circle of rotation (that is, the light of the same color in the two groups three-color light with same time-sequence periods has the same angle). Therefore, the frequency of emitting the three-color light by the phosphor wheel is improved while the original rotation speed remains.

In one implementation, to enable the phosphor wheel to emit two groups of same three-color light in one circle of rotation, the central angles of the above different regions of the phosphor wheel may be equal.

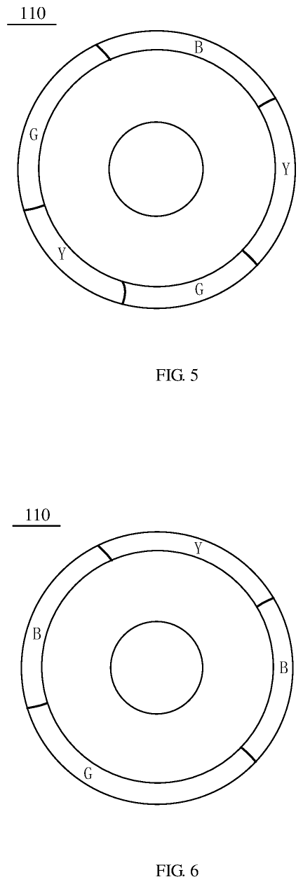

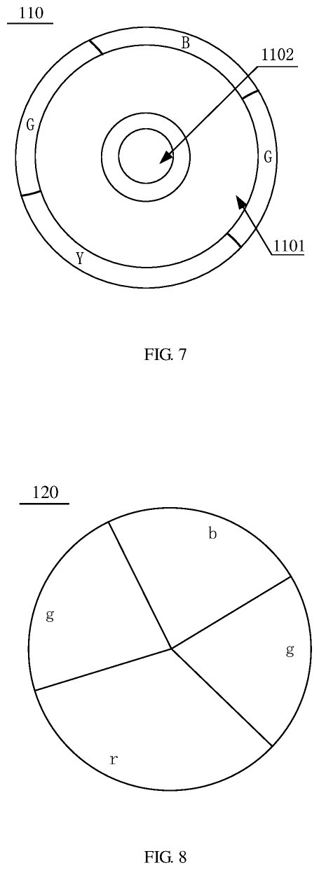

In some examples, as shown in FIG. 3, the arrangement sequence of the plurality of regions is the yellow fluorescence region Y, the green fluorescence region G, the transmission region B and the green fluorescence region G. In some examples, as shown in FIG. 4, the arrangement sequence of the plurality of regions is the transmission region B, the yellow fluorescence region Y, the green fluorescence region G and the yellow fluorescence region Y. In some examples, as shown in FIG. 5, the arrangement sequence of the plurality of regions is the green fluorescence region G, the yellow fluorescence region Y, the green fluorescence region G, the yellow fluorescence region Y and the transmission region B. For some examples, as shown in FIG. 6, the arrangement sequence of the plurality of regions is the transmission region B, the yellow fluorescence region Y, the transmission region B and the green fluorescence region G.

In other implementation, a size of the area for each regions, i.e. the size of a central angle corresponding to each region in the plurality of regions, may be determined according to an actual situation.

In some scenarios, the color and a time length of the light emitted from the plurality of regions is related to the arrangement sequence of the plurality of regions, the sizes of the central angles corresponding to the plurality of regions and the rotation speed of the phosphor wheel. Illustratively, as shown in FIG. 3, it is assumed that the arrangement sequence of the plurality of regions is the yellow fluorescence region, the green fluorescence region, the transmission region and the green fluorescence region, the sizes of the central angles corresponding to the plurality of regions are 100°, 80°, 100° and 80° respectively, and the rotation speed of the phosphor wheel is 120 Hz. In this case, the time length of the yellow fluorescence emitted from the yellow fluorescence region is Tr, and Tr=( 100/360)×( 1/120) seconds; the time length of the green fluorescence emitted from each green fluorescence region is Tg, and Tg=( 80/360)×( 1/120) seconds; the time length of the blue laser light emitted from the transmission region is Tb, and Tb=( 100/360)×( 1/120) seconds. If the phosphor wheel starts rotating from one end of the transmission region, the phosphor wheel may begin emitting the green fluorescence after a time length Tb lapses, emits the yellow fluorescence after a following time length Tg lapses, emits the green fluorescence after a following time length Tr lapses, and emits the blue laser light after a further following time length Tg lapses, and so on.

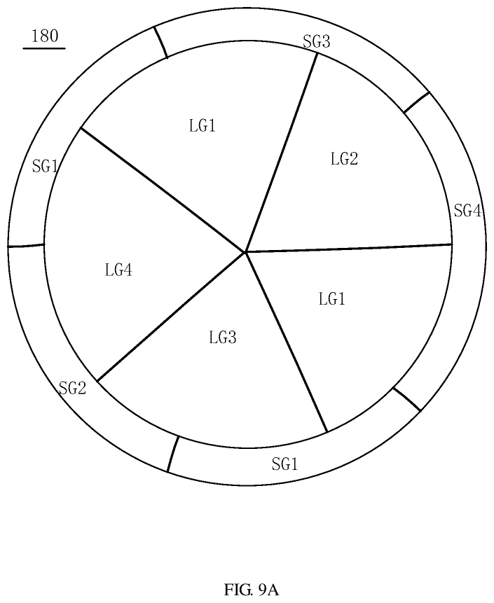

In some examples, as shown in FIG. 7, the phosphor wheel 110 further includes a driving structure 1102. The driving structure 1102 is in a central region of the ring substrate 1101. Further, the driving structure 1102 is connected with the substrate 1101, and configured to drive the substrate 1101 to rotate. Illustratively, the driving structure 1102 may include a motor. The driving structure 1102 may be fixedly connected with the substrate 1101 through a ring connector (not shown in FIG. 7), and the driving structure 1102 and the substrate 1101 are connected more tightly by the ring connector. Illustratively, the ring connector may include a ring metal sheet. Because metal has good ductility, the ring connector is not easily broken after being subjected to a rotational force generated by the rotation of the driving structure for long. In this case, an effective connection between the driving structure and the substrate is guaranteed.

FIG. 8 is a schematic diagram illustrating a structure of a filter wheel according to some examples of the present disclosure. The filter wheel 120 includes a red filter region r, a green filter region g and a light transmission region b. The red filter region r is configured to obtain red light by filtering out yellow fluorescence, the green filter region is configured to obtain green light by passing through green fluorescence, and the light transmission region b is configured to transmit laser light or fluorescence. Descriptions are made with the filter wheel 120 including one red filter region r, two green filter region g and one light transmission region b as an example, as shown in FIG. 8.

In one implementation, an arrangement of a plurality of regions of the filter wheel may exactly match to an arrangement of a plurality of regions of the phosphor wheel. Therefore, when the arrangement sequence of the plurality of regions of the phosphor wheel changes, the arrangement sequence of the plurality of filter regions of the filter wheel may correspondingly change.

When the arrangement sequence of the plurality of regions of the phosphor wheel is YGBG shown in FIG. 3, the arrangement sequence of the plurality of regions of the filter wheel correspondingly is the red filter region, the green filter region, the light transmission region and the green filter region.

When the arrangement sequence of the plurality of regions of the phosphor wheel is BYGY shown in FIG. 4, the arrangement sequence of the plurality of regions of the filter wheel correspondingly is the light transmission region, the red filter region, the green filter region and the red filter region.

When the arrangement sequence of the plurality of regions of the phosphor wheel is GYGYB shown in FIG. 5, the arrangement sequence of the plurality of regions in the filter wheel correspondingly is the green filter region, the red filter region, the green filter region, the red filter region and the light transmission region.

When the arrangement sequence of the plurality of regions of the phosphor wheel is BYBG shown in FIG. 6, the arrangement sequence of the plurality of regions of the filter wheel correspondingly is the light transmission region, the red filter region, the light transmission region and the green filter region.

Further, as shown in FIG. 2, the laser light source 10 further includes a light beam-shaping component 150, a light combining component 140 and a light collecting component 160. The light beam-shaping component 150, the light combining component 140, the filter wheel 120 and the light collecting component 160 are arranged sequentially along a laser light transmission direction.

The light beam-shaping component 150 is configured to shape laser light and transmit the shaped laser light to the light combining component 140. The shaping process includes compressing the parallel laser light into parallel laser light with a small cross-section area. Therefore, the light beam-shaping component 150 improves transmittance of the parallel laser light in subsequent optical devices (such as the light combining component, the phosphor wheel, the filter wheel and the light collecting component). Illustratively, the light beam-shaping component 150 is a telescope system. In some scenarios, the telescope system includes at least one convex lens and/or at least one concave lens. The light combining component 140 is configured to transmit the shaped laser light to the phosphor wheel 110. The light combining component 140 is further configured to transmit the laser light transmitted from the phosphor wheel 110 to the filter wheel 120, where the laser light transmitted from the phosphor wheel 110 is a laser light transmitted by the transmission region after the shaped laser light is irradiated onto the transmission region of the phosphor wheel 110. The light combining component 140 is further configured to transmit the fluorescence emitted from the phosphor wheel 110 to the filter wheel 120, where the fluorescence is generated by irradiating the shaped laser light to the fluorescence region. Illustratively, the light combining component 140 includes a light combining dichroic mirror, dichroic plate, dichroic cube, or dichroic beam-splitter. The light collecting component 160 is configured to perform homogenization (or dodging) for the received red light, blue light and green light. Illustratively, the light collecting component 160 is a light rod, such a light-homogenized rob. When the laser is a blue laser, the laser light to be shaped is blue laser light.

Illustratively, a light emitting process of the laser light source is as follows: the blue laser light is emitted by the laser 130, shaped by the light beam-shaping component 150, emitted to the light combining component 140, and then transmitted to the phosphor wheel 110; the phosphor wheel 110 rotates in a time sequence; when the blue laser light is irradiated to the transmission region on the phosphor wheel 110, the blue laser light is transmitted through the phosphor wheel 110, re-transmitted by the light combining component 140 to the filter wheel 120 after passing through a relay optical loop (refer to an optical loop from the phosphor wheel 110 to the light combining component 140 in FIG. 2), and then enters the light collecting component 160 through the filter wheel 120; when the blue laser light is irradiated to the fluorescence region on the phosphor wheel 110, the phosphor powder on the fluorescence region is excited to emit fluorescence (for example, the yellow fluorescence and/or green fluorescence in FIG. 2), the excited fluorescence is reflected and transmitted towards the filter wheel 120 through the light combining component 140, and then enters the light collecting component 160.

In some examples, since the blue laser light is transmitted to the phosphor wheel 110 through the light combining component 140 and then transmitted to the filter wheel 120 after passing through the transmission region of the phosphor wheel 110, the phosphor wheel 110 and the filter wheel 120 are at both sides of the light combining component 140 respectively.

In one implementation, the phosphor wheel 110 and the filter wheel 120 may be disposed heteroaxially. Compared with coaxial disposal, this heteroaxial disposal facilitates assembly of the phosphor wheel 110 and the filter wheel 120, reducing the assembly complexity. Further, to filter the fluorescence emitted from the phosphor wheel 110 by the filter wheel 120, the phosphor wheel 110 and the filter wheel 120 are configured to rotate synchronously.

In some examples, a proportion of a central angle of the above red filter region on the filter wheel 120 is equal to a proportion of a central angle of the yellow fluorescence region on the phosphor wheel 110. A proportion of a central angle of the green filter region on the filter wheel 120 is equal to a proportion of a central angle of the green fluorescence region on the phosphor wheel 110. A proportion of a central angle of the light transmission region on the filter wheel 120 is equal to a proportion of a central angle of the transmission region on the phosphor wheel 110.

Since the phosphor wheel 110 and the filter wheel 120 rotate synchronously, the red filter region, the green filter region and the light transmission region on the filter wheel 120 are designed to have central angle proportions respectively equal to those of the yellow fluorescence region, the green fluorescence region and the transmission region on the phosphor wheel 110 and also have an arrangement sequence corresponding to that of the yellow fluorescence region, the green fluorescence region and the transmission region on the phosphor wheel 110. Therefore, it is ensured that yellow light is completely filtered out after the yellow fluorescence passes through the red filter region of the filter wheel 120 when the phosphor wheel 110 emits the yellow fluorescence, so that the filter wheel emits red light; when the phosphor wheel 110 emits the green fluorescence, the filter wheel 120 emits green light after the green fluorescence passes through the green filter region of the filter wheel 120; when the phosphor wheel 110 transmits the blue laser light, the filter wheel 120 emits blue light after the blue laser light passes through the light transmission region of the filter wheel 120. In this case, the laser light source emits light effectively. Meanwhile, since the color wheel generates red light by filtering the yellow fluorescence, proportions of other primary color light components of the laser light source other than the red primary color component are increased.

In another implementation, the phosphor wheel 110 and the filter wheel 120 may be also disposed coaxially, as long as the fluorescence and the blue laser light emitted by the phosphor wheel 110 can be transmitted to the filter wheel 120.

In some examples, the phosphor wheel and the filter wheel are on the same substrate, and a plurality of regions of the phosphor wheel surround a plurality of regions of the filter wheel. Optionally, the phosphor wheel and the filter wheel are configured to rotate synchronously.

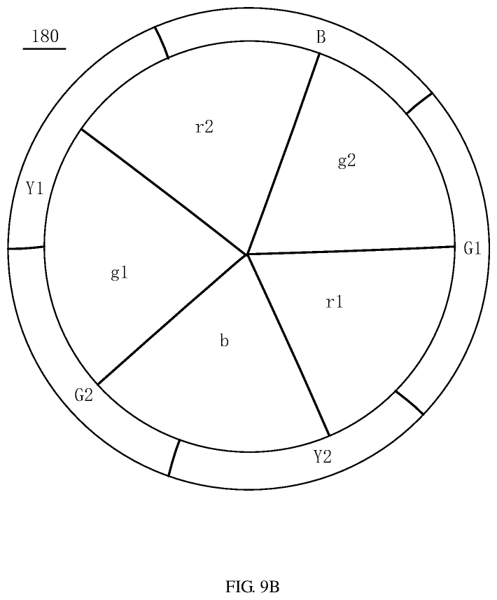

In some examples, as shown in FIG. 9A, the color wheel 180 includes a plurality of regions arranged along a first circumferential direction. The plurality of regions arranged along the first circumferential direction include at least one pair of first regions SG1 where emitted light is of a same color, and one second region SG2 is spaced between the first regions SG1 of each pair. The light emitted from the first region SG1 and the second region SG2 has different colors. Either of the first region SG1 and the second region SG2 is a fluorescence region. The color wheel 180 further includes a plurality of regions arranged along a second circumferential direction. The plurality of regions arranged along the second circumferential direction includes some filter regions corresponding to the first region SG1 and the second region SG2. The color wheel outputs red light, blue light and green light in a time sequence.

In the above examples, to provide a complete time sequence of three-primary-color light, regions SG3 and SG4 arranged along the first circumferential direction output the same color, or the regions SG4 and SG2 output the same color. The first circumferential direction and the second circumferential direction are arranged in a radial direction of the color wheel. Specifically, the first circumferential direction is at an outer side of the color wheel 180, and the second circumferential direction is at an inner side of the color wheel 180.

With the above color wheel structure, the first color regions are symmetrically disposed relative to the second color region, so that the second color region is actually divided into two second color regions. At least one spoke region is reduced when the second color region forms a time sequence of three primary colors with each first color region respectively. Therefore, a small amount of spoke light is generated when the color wheel provides the primary-color light of several time sequence periods in one circle of rotation.

In other examples, as shown in FIG. 9B, the phosphor wheel and the filter wheel are coaxial and disposed on the same substrate. A phosphor wheel region and a filter wheel region are on the substrate. The phosphor wheel region realizes the above functions of a plurality of regions of the phosphor wheel, that is, the phosphor wheel region includes the above plurality of regions of the phosphor wheel. The filter wheel region realizes the above functions of a plurality of filter regions of the filter wheel, that is, the filter wheel region includes the above plurality of filter regions of the filter wheel. The phosphor wheel region surrounds the filter wheel region, and the phosphor wheel region is at the outer side of the color wheel.

Descriptions are made with the phosphor wheel region including a yellow fluorescence region Y1, a transmission region B, a green fluorescence region G1, a yellow fluorescence region Y2 and a green fluorescence region G2 and the filter wheel region including a red filter region r1, a light transmission region b, a green filter region g1, a red filter region r2 and a green filter region g2 as shown in FIG. 9B. When the phosphor wheel and the filter wheel as above are on the same substrate, the structure is referred to as the color wheel 180. By disposing the phosphor wheel and the filter wheel on the same substrate and allowing the color wheel to be multi-functional, the number of system components is reduced, thereby facilitating miniaturization, reducing manufacturing processes and decreasing manufacturing costs.

Since the optical engine generates an image beam through pure color light only, the light collecting component selectively receives the pure color light to enable the laser light source to emit the pure color light. In some scenarios, an angle of the spoke light to be shielded by the light collecting component is determined through a color correction process, so that the light collecting component does not receive the spoke light. The angle of the spoke light may include an angular size of the spoke light and/or an angular position of the spoke light. For example, one spoke light may include a size of about 11° and at an angular position of about 50° relative to a center of green fluorescence region. Here, “about” a value may refer to a range between 90% and 110% of the value, inclusive.

In one implementation, the color correction process is performed by software corresponding to the size of the optical engine in the current laser projector. Image quality requirements of the laser projector are set in the software. An angle of the spoke light generated is determined based on the rotation rate of the phosphor wheel, the arrangement sequence of regions of the phosphor wheel, the sizes of central angles corresponding to the plurality of regions of the phosphor wheel according to the requirements. The color correction process is a process of determining the angle of spoke light on the phosphor wheel. Since the color wheel structure in the examples of the present disclosure only generates four or five regions of spoke light, the time of performing the color correction process is effectively shortened.

Illustratively in one example, it is assumed that the size of a light valve of the optical engine is 0.47 inches, the image quality requirement is to display 4K image quality, the rotation rate of the phosphor wheel is 120 Hz, and the arrangement sequence of the regions of the phosphor wheel is the yellow fluorescence region, the green fluorescence region, the transmission region and the green fluorescence region. In this case the sizes of central angles corresponding to a plurality of regions of the phosphor wheel are 100°, 80°, 100° and 80° respectively. Based on the aforementioned parameters, by the software corresponding to the optical engine of 0.47 inches, it is determined that four regions of spoke light exist, and the angle of each region of spoke light is about 11°.

Further, to improve the brightness of the laser light source, the angles of the red filter region and the light transmission region on the filter wheel are changed correspondingly while the angles of the yellow fluorescence region, the green fluorescence region and the transmission region of the phosphor wheel are changed, so that an orthographic projection of the yellow fluorescence region on the filter wheel is staggered by a particular region relative to the red filter region. In this case, a yellow light waveband of partial yellow fluorescence is retained, that is, the yellow light that does not pass through the red filter region (i.e., the yellow light in the above staggered region) is not filtered out, thereby increasing the brightness of the laser light source.

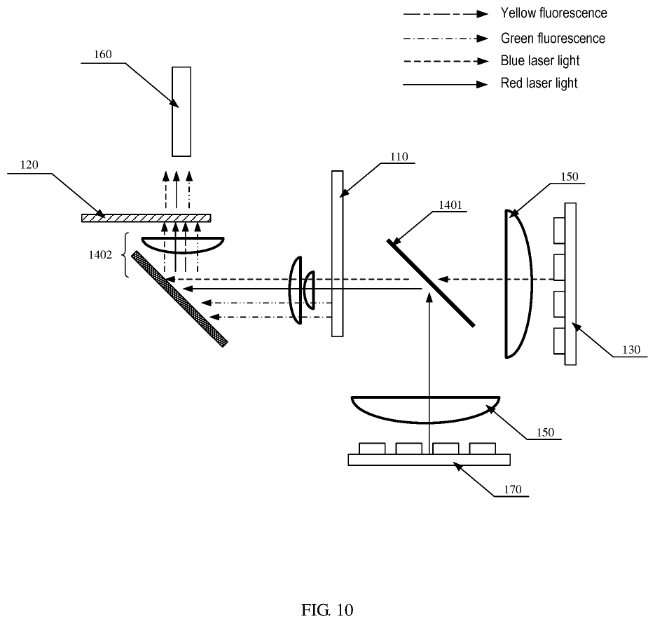

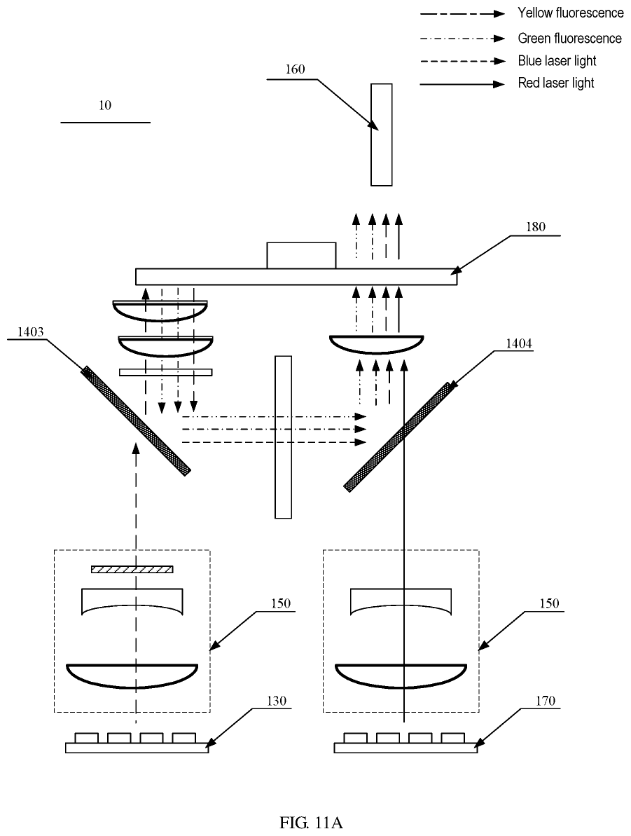

FIG. 10 is a schematic diagram illustrating a structure of another laser light source 10 according to another embodiment of the present disclosure. Descriptions are made with the laser light source including a dual-color laser source as shown in FIG. 10. For example but not limited to, it is assumed that one laser is a blue laser, and the other laser is a red laser.

In FIG. 10, the laser light source 10 further includes a red laser 170, and the red laser 170 is configured to emit red laser light. Structures and principles of the blue laser, the phosphor wheel and the filter wheel in FIG. 10 are referred to the aforementioned laser light source 10 shown in FIG. 2, which will not be described herein.

Illustratively, a light emitting process of the laser light source is as follows: blue laser light emitted by a blue laser 130 is shaped by a light beam-shaping component 150, and emitted to a first light combining component 1401, red laser light emitted by a red laser 170 is shaped by the light beam-shaping component 150, and emitted to the first light combining component 1401, and the blue laser light and the red laser light are then transmitted to the phosphor wheel 110; the phosphor wheel 110 rotates in a time sequence; when the blue laser light and the red laser light are irradiated to the transmission region on the phosphor wheel 110, the blue laser light and the red laser light are transmitted through the phosphor wheel 110 to the filter wheel 120 through a second light combining component 1402, and then enter the light collecting component 160; when the blue laser light is irradiated to the fluorescence region on the phosphor wheel 110, phosphor powder on the fluorescence region is excited to emit fluorescence of at least one color (for example, the yellow fluorescence and/or green fluorescence in FIG. 10). The excited fluorescence is reflected to the filter wheel 120 by the second light combining component 1402, and then enters the light collecting component 160.

In the above implementation, the red light entering the light collecting component 160 includes the red laser light emitted by the red laser and the red fluorescence obtained by filtering the yellow fluorescence through the filter wheel.

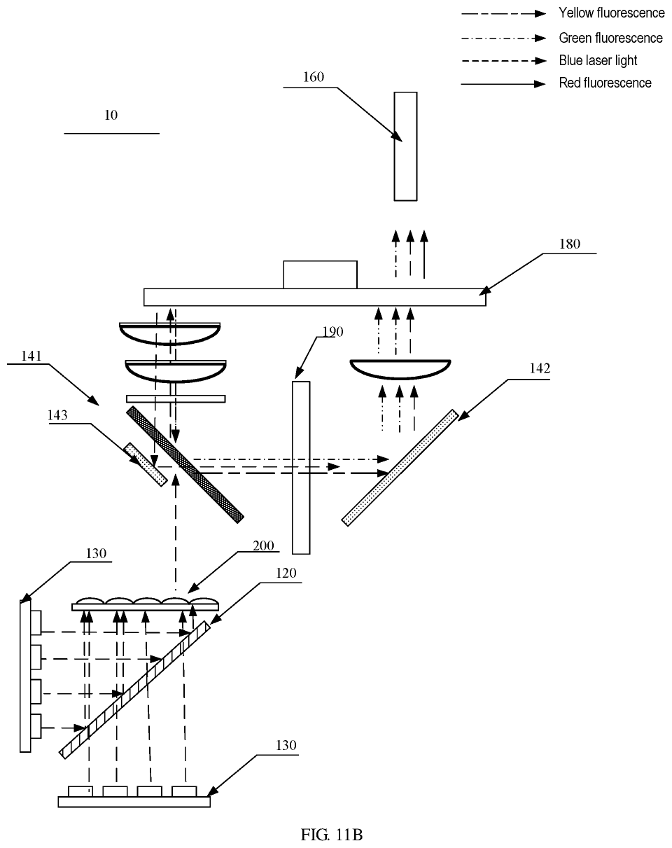

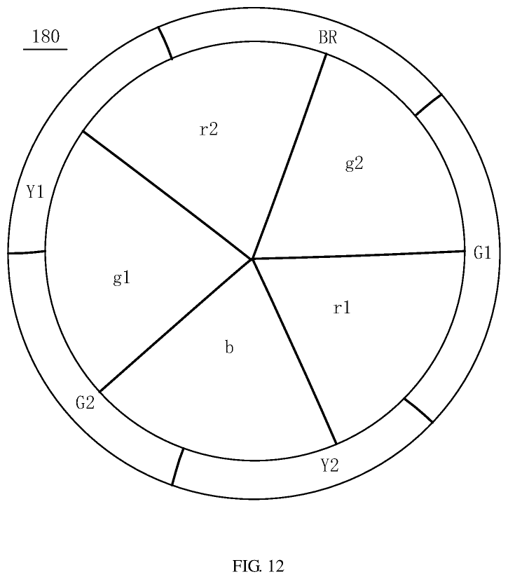

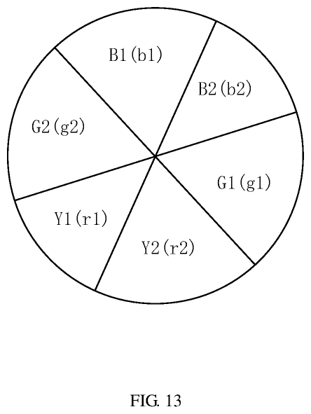

FIG. 11A is a schematic diagram illustrating a structure of another embodiment of a laser light source in the present disclosure. In FIG. 11A, the phosphor wheel and the filter wheel are on the same substrate in the structure of the laser light source according to the examples.

As shown in FIG. 11A, the laser light source 10 includes a first laser 130 and a second laser 170. In one implementation, the first laser 130 is a blue laser, which emits blue laser light, and the second laser 170 is a red laser, which emits red laser light, wherein the blue laser light is used as exciting light of fluorescence.

Structures and principles of the blue laser in FIG. 11A are referred to the aforementioned laser light source 10 shown in FIG. 2, and structures and principles of the red laser in FIG. 11A are referred to the aforementioned laser light source 10 shown in FIG. 10, which will not be described herein.

Illustratively, a light emitting process of the laser light source is as follows: the blue laser light emitted by the blue laser 130 is shaped by the light beam-shaping component 150, emitted to a third light combining component 1403, and transmitted to the phosphor wheel region of the color wheel 180 through the third light combining component 1403; the red laser light emitted by the red laser 170 is shaped by the light beam-shaping component 150, emitted to a fourth light combining component 1404, and then transmitted to the filter wheel region of the color wheel 180 through the fourth light combining component 1404, and enters the light collecting component 160.

The color wheel 180 rotates in a time sequence. When the blue laser light is irradiated to the fluorescence region of the phosphor wheel on the color wheel 180, the phosphor powder on the fluorescence region is excited to emit fluorescence of at least one color (for example, the yellow fluorescence and/or green fluorescence in FIG. 11A). The excited fluorescence may propagate towards the third light combining component 1403, may be reflected to the filter wheel region on the color wheel 180 through the third light combining component 1403 and the fourth light combining component 1404, and then enters the light collecting component 160. When the blue laser light is irradiated to a light scattering region of the phosphor wheel on the color wheel 180, the blue laser light is reflected from the light scattering region to the third light combining component 1403, reflected to the filter wheel region on the color wheel 180 through the third light combining component 1403 and the fourth light combining component 1404, and then enters the light collecting component 160.

In some examples, a central angle of a fan shape where each fluorescence region in the phosphor wheel is located and a central angle of each filter region that is in the filter wheel and corresponds to each fluorescence region are vertical angles (or opposite angles). A central angle of a fan shape where the light scattering region of the phosphor wheel is located and a central angle of the light transmission region that is in the filter wheel and corresponds to the laser light scattering region are vertical angles (or opposite angles).

In one implementation, in the color wheel structure 180 shown in FIG. 12, the phosphor wheel region includes a yellow fluorescence region Y1, a light reflection region BR, a green fluorescence region G1, a yellow fluorescence region Y2 and a green fluorescence region G2, and the filter wheel region includes a red filter region r1, a light transmission region b, a green filter region g1, a red filter region r2 and a green filter region g2. The phosphor wheel region and the filter wheel region of the color wheel structure 180 are on the substrate, and the substrate is a ring metal substrate. A reflection surface is disposed at a side that is on the metal substrate and faces laser light incidence. The reflection surface is realized by coating film, or the metal substrate is polished into a mirror surface to realize reflection of a full-spectrum light beam. Further, in the ring metal substrate, the filter wheel region is fixed to an inner circle of the color wheel in an embedding or bonding manner, and an outer circle of the ring metal substrate is the phosphor wheel region. Specifically, the phosphor wheel region includes fluorescence regions (a yellow fluorescence region Y and a green fluorescence region G) coated with phosphor powder and the light reflection region BR. The light reflection region BR is coated with a scattering layer, and the scattering layer is configured to scatter the laser passing through the layer, achieving an effect of effectively eliminating a light spot. In this case, the blue laser light is reflected by the light reflection region of the color wheel 180 to the light combining component.

In another implementation, the structure of the color wheel 180 as shown in FIG. 9B is taken as an example. The phosphor wheel region of the color wheel 180 includes a transmission region B. As such, another optical loop is at a side that is on the color wheel and away from the blue laser. The blue laser light is transmitted from the transmission region of the color wheel 180, and transmitted to the light combining component through the optical loop.

FIG. 11B is a schematic diagram illustrating a structure of another embodiment of a laser light source in the present disclosure. The laser light source 10 shown in FIG. 11B includes a plurality of groups of first lasers 130 for improving the brightness of the laser light source.

The plurality of groups of first lasers 130 are all blue lasers. For example, two groups of lasers are vertically arranged in space, or one group is perpendicular to another group. Laser light from the two groups of lasers may be combined by a step mirror. In one implementation, the step mirror may include a transmission plate with periodical reflective film strips disposed on one side.

Optionally, as shown in FIG. 11B, light combination is performed by a first light combining lens 120 with pieces of reflective film disposed periodically. Consequently, light beams emitted from a first group of lasers are all irradiated onto a reflection film region including the pieces of reflective film, and light beams emitted from a second group of lasers are all irradiated to the transmission region which has no reflective film. As such, light beams emitted from the first group of lasers are reflected, and light beams emitted from the second group of lasers are transmitted, and both of the groups of light beams are emitted and combined in a same direction. Thus, the size of the light spot is reduced after light combination.

In some examples, the combined laser beam further passes through a light homogenizing component before reaching the color wheel, and the light homogenizing component is a fly-eye lens 200. After light homogenization, energy of the laser beam is distributed more uniformly, helping to improve an excitation efficiency of fluorescence.

In one implementation, the color wheel 180 may include a color wheel structure shown in FIG. 10.

Specifically, after being homogenized by the fly-eye lens 200, the blue laser beam also passes through a converging lens (not shown) to further reduce an area of the light spot, and then is transmitted to the second light combining lens 141. The second light combining lens 141 is a dichroic lens transmitting blue light and reflecting the light of colors other than the blue light, such as yellow fluorescence and green fluorescence.

The transmitted blue light may be transmitted to the fluorescence regions in a plurality of regions arranged along the first circumferential direction (i.e., an outer circumferential direction shown) on the color wheel 180, and the arrangement of the fluorescence regions is referred to the above examples. The fluorescence regions include a yellow fluorescence region and a green fluorescence region, and are excited to generate the fluorescence of a corresponding color.

The fluorescence is transmitted into the second light combining lens 141 after being reflected by the metal substrate. The fluorescence having a plurality of colors is all reflected to a fourth reflecting lens 142 by the second light combining lens, and then reflected by the fourth reflecting lens 142 to the filter regions in a plurality of regions arranged along the second circumferential direction (i.e., an inner circumferential direction shown). The division of the filter regions is referred to the above example. Therefore, the fluorescence is filtered and output by a corresponding filter region.

With the rotation of the color wheel, when the laser light is irradiated to the laser light scattering region in a plurality of regions arranged along the first circumferential direction, a scattering layer included in the laser light scattering region diverges and scatters the laser light at different angles. Similarly, the laser light is reflected by the metal substrate, and then returned to the second light combining lens 141 after being passed through the scattering layer again. The second light combining lens 141 transmits the blue laser light towards a third reflecting lens 143. The size of the third reflecting lens 143 is less than the size of the second light combining lens 141, and is only configured to receive a laser beam.

The blue laser light is reflected to a fourth reflecting lens 142 by the third reflecting lens 143, and then reflected by the fourth reflecting lens 142 to the light transmission region in a plurality of regions arranged along the second circumferential direction. The light transmission region is configured to transmit the laser light. The light transmission region may include a flat glass, or a diffuser.

The light collecting component 160, for example, a light rod, is disposed corresponding to a light emitting position of the inner circumference of the color wheel.

In some examples, a field lens 190 is also between the second light combining lens 141 and the fourth reflecting lens 142. The field lens is configured to compress an angle of a light beam reflected by the second light combining lens 141 and the third reflecting lens 143, thereby reducing the size of the light spot.

In some examples, a collimating lens (not shown) is also between the second light combining lens 141 and the color wheel 180. The collimating lens is configured to further compress a divergence angle of the laser beam incident to the color wheel and collimate the reflected light beam of a large angle emitted by the color wheel.

In some examples, a focusing lens (not shown) is also between the light emitting position of the color wheel 180 and the light collecting component 160. The focusing lens is configured to compress the light beam output by the color wheel and transmit the compressed light beam into the light rod.

In conclusion, the color wheel structure in the laser light source according to some examples of the present disclosure allows the color wheel to generate only a small amount of spoke light while providing primary-color light of several time sequence periods in one circle of rotation when the light spot passes through the color wheel. For example, when a plurality of regions of the phosphor wheel are in the arrangement sequences as shown in FIG. 3, FIG. 4 and FIG. 6, the color wheel generates only 4 regions of spoke light. When the plurality of regions of the phosphor wheel are in the arrangement sequence as shown in FIG. 5, the color wheel generates only 5 regions of spoke light. On one hand, the reduction of the number of regions of spoke light reduces the complexity of performing light processing for this region by the electronic software program. For example, if the mixed color segment is not discarded but utilized, the duration of the mixed color segment is determined by performing recalculation for a proportion of white balance and accurately controlling a rotation position of the color wheel and then utilized, so that a reduced amount of spoke region light causes the control complexity of the electronic software to be reduced.

On the other hand, when the spoke light is discarded, losses of a plurality of types of primary color light are reduced according to the above solution with less spoke region light. Therefore, a brightness loss of a whole projection picture is reduced, an influence of the lost primary color light on the proportion of the original white balance is also lowered, and a high-quality projection picture display is facilitated.

Further, by disposing a multi-zone color segment, the color wheel is enabled to provide, for one circle of rotation, complete light of three colors of at least two time-sequence periods, which is also referred to as tri-color light (i.e., a three-primary-color light component). Therefore, a rotation speed of the color wheel is increased, time of emitting one group of complete light of three colors by the color wheel is shortened, and a probability of occurrence of “a rainbow phenomenon” is reduced, thereby improving watching quality of the projection picture.

FIG. 1 illustrates a laser projector according to some examples of the present disclosure. The laser projector includes a laser light source 10, an optical engine 20 and a projection lens 30. The laser light source 10 is any of the above laser light sources. The optical engine 20 is between the laser light source 10 and the projection lens 30. The optical engine 20 is configured to modulate a light beam emitted from the laser light source 10 into an image beam when irradiated by the light beam. Illustratively, the optical engine includes a light valve, the light valve is a Digital Micro mirror Device (DMD), and the DMD includes a plurality of reflection mirrors. When the light beam is irradiated to the DMD, the DMD deflects the reflection mirror at a position where a same color in an image to be displayed is present according to the color of the received light beam, so that the light beam generates the image beam through reflection of the deflected reflection mirror. The projection lens 30 is configured to project the image beam onto a projection screen.

The regions of the phosphor wheel are arranged in different arrangement sequences, and therefore the light beams of different colors are also emitted by the laser light source in different sequences. When the light valve is irradiated by the light beam emitted from the laser light source, the light beam is modulated into the image beam according to the arrangement sequence of a plurality of regions of the phosphor wheel on the substrate. Illustratively, it is assumed that the arrangement sequence of a plurality of regions of the phosphor wheel is shown in FIG. 3. If the rotation frequency of the color wheel (a collective name of the phosphor wheel and the filter wheel) is same as the frequency of displaying image by the laser projector, the light beams emitted by the laser light source are irradiated onto the light valve in a sequence of red light, green light, blue light and green light during one circle of rotation of the color wheel. The light valve sequentially generates component image beams of corresponding colors according to the sequence of received red light, green light, blue light and green light. Finally, the component image beams are superimposed to form a complete image beam. Since the component image beam of the same color is also formed by superimposing a plurality of sub-image beams of the color, the light valve also generates a first sub-image beam according to a part of the received red light, generates a second sub-image beam according to the remaining part of the received red light, and forms a component image beam corresponding to the color by superimposing the first sub-image beam and the second image beam. Similarly, the component image beam generated correspondingly by the blue light is also formed by superimposing the sub-image beams. In this way, flexibility of generating the image beam by the light valve is improved.

As described above, the laser projector according to some examples of the present disclosure allows the color wheel to generate only a small amount of spoke light due to the color wheel structure of the laser light source while providing the primary color light of several time sequence periods in one circle of rotation of the color wheel when the light spot passes through the color wheel. On one hand, the complexity of performing light processing for this region by the electronic software program is lowered. For example, if the mixed color segment is not discarded but utilized, the duration of the mixed color segment is determined by performing recalculation for a proportion of white balance and accurately controlling a rotation position of the color wheel and then utilized, so that a reduced amount of spoke region light causes the control complexity of the electronic software to be reduced. On the other hand, when the spoke light is discarded, losses of a plurality of types of primary color light are reduced according to the above solution with less spoke region light. Therefore, a brightness loss of a whole projection picture is reduced, an influence of the lost primary color light on the proportion of the original white balance is also lowered, and a high-quality projection picture display is facilitated.

As described above, when the arrangement sequence of a plurality of regions of the phosphor wheel is shown in FIG. 3, the sequence of the component image beams generated by the optical engine is a red component image beam, a green component image beam, a blue component image beam and a green component image beam. When the arrangement sequence of a plurality of regions of the phosphor wheel is shown in FIG. 4, the sequence of the component image beams generated by the optical engine is a blue component image beam, a red component image beam, a green component image beam and a red component image beam. When the arrangement sequence of a plurality of regions of the phosphor wheel is shown in FIG. 5, the sequence of the component image beams generated by the optical engine is a green component image beam, a red component image beam, a green component image beam, a red component image beam and a blue component image beam. When the arrangement sequence of a plurality of regions of the phosphor wheel is shown in FIG. 6, the sequence of the component image beams generated by the optical engine is a blue component image beam, a red component image beam, a blue component image beam and a green component image beam. As such, since the regions of the color wheel are arranged in different sequences, the light beams of different colors are emitted by the laser light source in different sequences, and the component image beams are also generated by the optical engine in different sequences, thereby improving the flexibility of generating the image beams by the optical engine.

After considering the specification and practicing the present disclosure, the persons of skill in the art may easily conceive of other implementations of the present disclosure. The present disclosure is intended to include any variations, uses and adaptive changes of the present disclosure. These variations, uses and adaptive changes follow the general principle of the present disclosure and include common knowledge or conventional technical means in the art not disclosed in the present disclosure. The specification and examples herein are intended to be illustrative only and the real scope and spirit of the present disclosure are indicated by the claims of the present disclosure.

In the description of the present disclosure, terms “a first” and “a second” are used only for descriptions and shall not be understood as indicating or implying relative importance or implying a number of the indicated technical features. Thus, elements limited by “a first” and “a second” may explicitly or implicitly include one or more features. In the descriptions of the present disclosure, “a plurality” refers to two or more unless otherwise stated clearly.

In the descriptions of the present specification, terms such as “an example”, “some examples”, “illustrative examples”, “embodiments”, “a specific example” or “some examples” are intended to refer to that a specific feature, structure, material, or characteristic described in combination with an embodiment or an example are included in at least one embodiment or example of the present disclosure. In the present specification, the illustrative expressions of the above terms do not necessarily refer to a same embodiment or example. Further, specific feature, structure, material or characteristic described above may be combined in a proper way in one or more embodiments or examples.

The foregoing disclosure is merely illustrative of preferred examples of the present disclosure but not intended to limit the present disclosure, and any modifications, equivalent substitutions, adaptations thereof made within the spirit and principles of the disclosure shall fall within the scope of the present disclosure.

1. A laser light source, comprising:
a first laser emitting first laser light; and
a phosphor wheel comprising a plurality of regions arranged along a first circumferential direction, wherein:
when the first laser light is transmitted onto the plurality of regions of the phosphor wheel, the plurality of regions of the phosphor wheel are configured to emit light comprising at least one of three colors,
the plurality of regions of the phosphor wheel comprise at least one pair of first regions configured to emit light of a same color,
the plurality of regions of the phosphor wheel comprise one second region spaced between each pair of the at least one pair of first regions, and
the light emitted from the first region and the light emitted from the second region comprise different colors.

2. The laser light source according to claim 1, further comprising:
a filter wheel comprising a plurality of regions arranged along a second circumferential direction, wherein an arrangement of the plurality of regions of the filter wheel is corresponding to an arrangement of the plurality of regions of the phosphor wheel.

3. The laser light source according to claim 2, wherein:
the phosphor wheel and the filter wheel are on a same substrate; and
the plurality of regions of the phosphor wheel surround the plurality of regions of the filter wheel.

4. The laser light source according to claim 3, wherein:
the plurality of regions of the phosphor wheel comprise a green fluorescence region, a yellow fluorescence region and a light scattering region; and
the plurality of regions of the filter wheel comprise a green filter region, a red filter region and a light transmission region.

5. The laser light source according to claim 2, wherein:
the plurality of regions of the phosphor wheel comprise a green fluorescence region, a yellow fluorescence region and a transmission region; and
the plurality of regions of the filter wheel comprise a green filter region, a red filter region and a light transmission region.

6. The laser light source according to claim 5, wherein:
the arrangement of the plurality of regions of the phosphor wheel comprises a sequence of a first green fluorescence region, a first yellow fluorescence region, a second green fluorescence region, a second yellow fluorescence region and a light transmission region; and
the arrangement of the plurality of regions of the filter wheel comprises a sequence of a first green filter region, a first red filter region, a second green filter region, a second red filter region and a light transmission region.

7. The laser light source according to claim 5, wherein:
the arrangement of the plurality of regions the phosphor wheel comprises a sequence of a yellow fluorescence region, a first green fluorescence region, a transmission region, a second green fluorescence region; and
the arrangement of the plurality of regions of the filter wheel comprises a sequence of a red filter region, a first green filter region, a light transmission region and a second green filter region.

8. The laser light source according to claim 5, wherein:
the arrangement of the plurality of regions of the phosphor wheel comprises a sequence of a transmission region, a first yellow fluorescence region, a green fluorescence region, a second yellow fluorescence region; and
the arrangement of the plurality of regions of the filter wheel comprises a sequence of a light transmission region, a first red filter region, a green filter region, and a second red filter region.

9. The laser light source according to claim 5, wherein:
the arrangement of the plurality of regions arranged along the first circumferential direction of the phosphor wheel comprises a sequence of a first transmission region, a yellow fluorescence region, a second transmission region and a green fluorescence region; and
the arrangement of the plurality of regions ar of the filter wheel comprises a sequence of a first light transmission region, a red filter region, a second light transmission region, a green filter region.

10. The laser light source according to claim 5, wherein:
a central angle of the yellow fluorescence region is equal to a central angle of the red filter region;
a central angle of the green fluorescence region is equal to a central angle of the green filter region; and
a central angle of the transmission region on the phosphor wheel is equal to a central angle of the light transmission region on the filter wheel.

11. The laser light source according to claim 2, further comprising:
a second laser emitting red laser light, wherein:
the red laser light is configured to transmit through a transmission region of the phosphor wheel and then incident on the filter wheel, or
the red laser light is directly incident on the filter wheel.

12. The laser light source according to claim 1, wherein:
each region on the phosphor wheel comprises at least one of a fan or fan-ring shape; and
central angles of each pair of the at least one pair of first regions are equal.

13. A laser light source, comprising:
a blue laser configured to emit blue laser light; and
a color wheel comprising a plurality of regions arranged along a first circumferential direction and a plurality of regions arranged along a second circumferential direction, the color wheel configured to output three primary colors in time sequence, the three primary colors comprising a red color, a blue color and a green color, wherein:
the plurality of regions arranged along the first circumferential direction comprise at least one pair of first regions configured to emit light of a same color,
the plurality of regions arranged along the first circumferential direction comprise one second region spaced between each pair of the at least one pair of first regions,
the light emitted from the first region and the light emitted from the second region comprise different colors,
a fluorescence region comprises at least one of: the first region, the second region, or the first and second regions, and
the plurality of regions arranged along the second circumferential direction comprise filter regions corresponding to the first region and the second region.

14. The laser light source according to claim 13, wherein:
the first circumferential direction and the second circumferential are arranged in a radial direction of the color wheel; and
the first circumferential direction is at an outer side of the color wheel and the second circumferential direction is at an inner side of the color wheel.

15. The laser light source according to claim 13, wherein:
the plurality of regions arranged along the first circumferential direction and the plurality of regions arranged along the second circumferential direction are on a same substrate; and
the same substrate comprises a metal substrate.

16. The laser light source according to claim 13, wherein:
the plurality of regions arranged along the first circumferential direction of the color wheel comprise two green fluorescence regions, two yellow fluorescence regions, and a light scattering region; and
the plurality of regions arranged along the second circumferential direction of the color wheel comprise two green filter regions, two red filter regions, and a light transmission region.

17. The laser light source according to claim 16, wherein:
a central angle of the yellow fluorescence region is equal to a central angle of the red filter region;
a central angle of the green fluorescence region is equal to a central angle of the green filter region; and
a central angle of the light scattering region is equal to a central angle of the light transmission region.

18. The laser light source according to claim 16, wherein:
a central angle of a fan shape of each of the plurality of regions arranged along the first circumferential direction of the color wheel and a central angle of a corresponding region arranged along the second circumferential direction of the color wheel are vertical angles; and
a central angle of a fan shape of the light scattering region and a central angle of a corresponding light transmission region are vertical angles.

19. The laser light source according to claim 13, further comprising:
a second laser configured to emit second light, wherein the blue laser light emitted from the blue laser and the light emitted from the second laser are combined into a combined light beam by a first combining lens, and the combined light beam is homogenized by a fly-eye lens;
a second light combining lens configured to transmit the blue laser light, wherein the blue laser light is transmitted into one of the plurality of regions arranged along the first circumferential direction after being transmitted by the second light combining lens;
a third reflecting lens;
a fourth reflecting lens; and
wherein:
a fluorescence region of the plurality of regions arranged along the first circumferential direction is excited to emit fluorescence by the blue laser light, such that the fluorescence is transmitted to the second light combining lens after being reflected; the second light combining lens is configured to reflect the transmitted fluorescence to the fourth reflecting lens; and the fourth reflecting lens is configured to reflect the reflected fluorescence to a filter region of the plurality of regions arranged along the second circumferential direction, and
a light scattering region is configured to scatter the blue laser light, such that the scattered light is reflected to the second light combining lens; the second light combining lens is configured to transmit the reflected light to the third reflecting lens; the third reflecting lens is configured to reflect the transmitted light to the fourth reflecting lens, and the fourth reflecting lens is configured to reflect the reflected light to a light transmission region of the plurality of regions arranged along the second circumferential direction.

20. A laser projector, comprising:
a laser light source configured to emit a light beam, the laser light source comprising:
a blue laser configured to emit blue laser light; and
a color wheel comprising a plurality of regions arranged along a first circumferential direction and a plurality of regions arranged along a second circumferential direction, the color wheel configured to output three primary colors in time sequence, the three primary colors comprising a red color, a blue color and a green color, wherein:
the plurality of regions arranged along the first circumferential direction comprise at least one pair of first regions configured to emit light of a same color,
the plurality of regions arranged along the first circumferential direction comprise one second region spaced between each pair of the at least one pair of first regions,
the light emitted from the first region and the light emitted from the second region comprise different colors,
the first region comprises a fluorescence region, and
the plurality of regions arranged along the second circumferential direction comprise filter regions corresponding to the first region and the second region;
an optical engine configured to modulate the light beam emitted from the laser light source into an image beam when irradiated by the light beam; and
a projection lens configured to project the image beam.
